(19) United States
(12) Patent Application Publication
(10) Pub. No.: US 2011/0103004 A1
(43) Pub. Date: May 5, 2011

(54) DOCKING STATION WITH EXTENDED USB INTERFACE FOR WIRELESS ELECTRO-OPTICAL READER

(75) Inventor: Christopher Warren BROCK, Manorville, NY (US)

(73) Assignee: SYMBOL TECHNOLOGIES, INC., Holtsville, NY (US)

(21) Appl. No.: 12/608,287

(22) Filed: Oct. 29, 2009

(51) Int. Cl. G06F 1/16; G06K 7/10; B23P 11/00

(52) U.S. Cl. 361/679.43; 235/454; 29/428

(57) ABSTRACT

A docking station supports a portable electro-optical reader, such as a moving laser beam reader or an imaging reader. The docking station includes a universal serial bus (USB) socket interface supported by the docking station, and a USB extension cable connected to the USB socket interface. The USB cable extends away from the docking station and terminates in a USB plug interface. A radio frequency (RF) peripheral is inserted into the USB socket interface, for wireless RF communication with the reader when the reader is not supported on the docking station. The USB cable is connected to power contacts on the docking station for mating with charging contacts connected to a rechargeable battery in the reader to charge the battery when the reader is supported by the docking station.

### DESCRIPTION OF THE RELATED ART

Moving laser beam readers or laser scanners have long been used to electro-optically read one- and two-dimensional bar code symbols. The moving laser beam reader generally includes a housing, a laser for emitting a laser beam, a focusing lens assembly for focusing the laser beam to form a beam spot having a certain size at a focal plane in a range of working distances relative to the housing, a scan component for repetitively scanning the beam spot across a target symbol in a scan pattern, for example, a scan line or a series of scan lines, across the symbol multiple times per second, a photodetector for detecting light reflected and/or scattered from the symbol and for converting the detected light into an analog electrical signal, and signal processing circuitry including a digitizer for digitizing the analog signal and a microprocessor for decoding the digitized signal based upon a specific symbology used for the symbol. The decoded signal is transmitted to a host, e.g., a cash register in a retail venue, for further processing, e.g., price look-up or inventorying.

Solid-state imaging systems or imaging readers have also been used to electro-optically read such symbols. The imaging reader includes a housing, a solid-state imager or sensor having an array of cells or photosensors, which correspond to image elements or pixels in a field of view of the imager, an illuminating light assembly for illuminating the field of view with illumination light from an illumination light source, e.g., a laser or one or more light emitting diodes (LEDs), and an imaging lens assembly for capturing return ambient and/or illumination light scattered and/or reflected from the symbol being imaged over a range of working distances. Such an imager may include a one- or two-dimensional charge coupled device (CCD) or a complementary metal oxide semiconductor (CMOS) device and associated circuits for producing electronic signals corresponding to a one- or two-dimensional array of pixel information over the field of view. Signal processing circuitry including a microprocessor processes the electronic signals to decode the symbol. An aiming light generator may also be provided in the housing for projecting an aiming light pattern or mark on the symbol prior to imaging. The decoded signal is transmitted to a host, e.g., a cash register in a retail venue, for further processing, e.g., price look-up or inventorying.

Both types of readers can be operated in a portable, wireless, handheld mode, in which an operator holds the respective wireless housing in his or her hand during reading. Electrical power to the electronic components in the wireless housing can be supplied via a rechargeable battery in the housing. When not in the handheld mode, the operator can park the housing in a docking station, which can serve myriad purposes, for example, as a hands-free reading station, or as a recharger for recharging the rechargeable battery, or as a convenient parking place to store the housing when not in active use. A radio frequency (RF) transceiver in the wireless housing communicates data, including data indicative of the symbol being read, as well as control data and update data, over a bi-directional wireless channel with a corresponding RF transceiver located in the host or the docking station.

As advantageous as such docking stations are, they are relatively expensive to manufacture, because they typically require relatively costly RF transceiver circuitry and power recharging circuitry to be accommodated therein, typically on one or more printed circuit boards (PCBs). The cost of such docking stations increases when a particular venue has a multitude of such docking stations, one for each reader.

In addition, a universal serial bus (USB) socket interface is typically provided at the back of the host. If a USB peripheral is desired to be installed, then an operator must stick his or her head and hand to the back of the host to gain access to the USB socket interface for insertion and pulling out a USB plug interface on the peripheral, thereby resulting in much inconvenience. Accordingly, there is a need for a less expensive docking station and better access to the USB socket interface at such venues.

### SUMMARY OF THE INVENTION

This invention generally relates to any electrical device and, more particularly, to a reader for electro-optically reading coded symbols, such as one- or two-dimensional bar code symbols. The reader includes a portable housing, preferably one having a handle held by an operator in a handheld mode during the reading, and an actuatable trigger mounted on the handle for initiating the reading when actuated by the operator. A docking station supports the housing in a docked state when the housing is not in the handheld mode, for example, when it is desired to recharge a rechargeable battery on-board the housing, or to conveniently park the housing when not in active use.

In one embodiment, the reader is a moving laser beam reader, which includes a laser for emitting the light as a laser beam, a scanner for sweeping the laser beam across the symbol as one scan line or a plurality of scan lines for reflection and scattering from the symbol as return light, and a photodetector for detecting the return light. In another embodiment, the reader is an imaging reader, which includes an illuminator for emitting the light as illumination light that illuminates the symbol, and a solid-state imager, such as a charge coupled device (CCD) or a complementary metal oxide semiconductor (CMOS) device, for detecting the return light. In each embodiment, a microprocessor or controller processes the return light to generate data corresponding to the symbol being read.

One feature of this invention resides, briefly stated, in supporting a universal serial bus (USB) socket interface on the docking station, and in connecting a USB extension cable to the USB socket interface. The USB cable extends away from the docking station and terminates in a USB plug interface. A radio frequency (RF) peripheral is advantageously connected to the USB socket interface, for wireless RF communication with an RF transceiver in the reader when the reader is not supported by the docking station. The USB plug interface is connected to a host, e.g., a cash register at a retail venue, to enable the wireless RF communication between the reader and the host.

Preferably, the USB cable is connected to power contacts on the docking station for mating with charging contacts connected to a rechargeable battery in the reader to charge the battery when the reader is supported by the docking station. The USB cable has four wires connected to the USB socket interface, and two of the wires are also connected to the power contacts.

Hence, in accordance with this invention, the docking station is less expensive than heretofore, because RF transceiver circuitry and power recharging circuitry are no longer required to be accommodated therein. Also, better access to the USB socket interface is obtained, because the USB socket interface is readily accessible at the docking station, and not the back of the host. An operator need no longer stick his or her head and hand to the back of the host to gain access to the USB socket interface for insertion and pulling out a USB plug interface on a USB peripheral.

Another feature of this invention resides, briefly stated, in a method of configuring a docking station for supporting a portable electro-optical reader. The method is performed by supporting a universal serial bus (USB) socket interface on the docking station, connecting a USB extension cable to the USB socket interface, extending the USB cable away from the docking station, and terminating the USB cable in a USB plug interface. Advantageously, the method includes connecting a radio frequency (RF) peripheral to the USB socket interface, for wireless RF communication with the reader when the reader is not supported on the docking station, and connecting the USB plug interface to a host to enable the wireless RF communication between the reader and the host.

Advantageously, the method includes connecting the USB cable to power contacts on the docking station for mating with charging contacts connected to a rechargeable battery in the reader to charge the battery when the reader is supported by the docking station. The USB cable is configured with four wires all connected to the USB socket interface, and two of the wires are connected to the power contacts.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a schematic diagram of a broken-away, handheld moving laser beam reader for electro-optically reading a coded symbol for use with a docking station in accordance with the present invention;

FIG. 2 is a schematic diagram of a broken-away, handheld imaging reader for electro-optically reading a coded symbol for use with a docking station in accordance with the present invention;

FIG. 3 is a schematic, part-sectional view depicting the reader of FIG. 1 or FIG. 2 in a docking station in accordance with the present invention; and

FIG. 4 is a schematic, wiring diagram depicting the wiring in the docking station of FIG. 3.

### DETAILED DESCRIPTION OF THE PREFERRED EMBODIMENTS

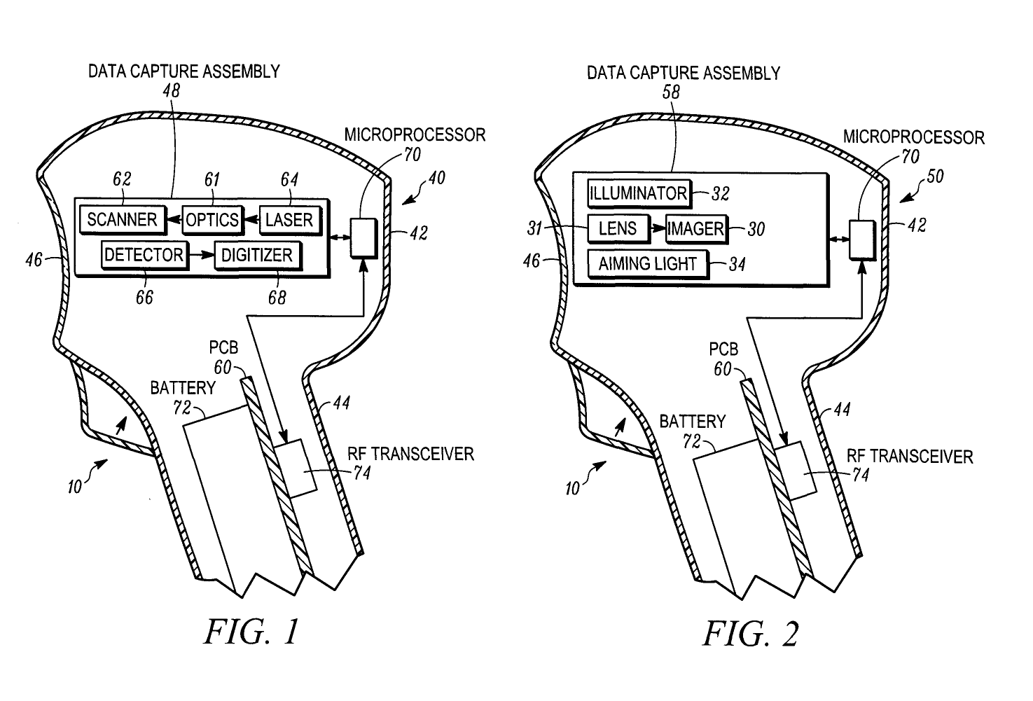

FIG. 1 depicts a moving laser beam reader 40 for electro-optically reading a target such as a coded symbol, that may use, and benefit from, the present invention. The beam reader 40 includes a scanner 62 in a portable, handheld housing 42 having a handle 44 on which a trigger 10 for initiating reading is mounted. The scanner 62 is operative for scanning an outgoing laser beam from a laser 64 and/or a field of view of a light detector or photodiode 66 in a scan pattern, typically comprised of one or more scan lines, multiple times per second, for example, one-hundred times per second, through a window 46 across the symbol for reflection or scattering therefrom as return light detected by the photodiode 66 during reading. The beam reader 40 also includes a focusing lens assembly or optics 61 for optically modifying the outgoing laser beam to have a large depth of field, and a digitizer 68 for converting an electrical analog signal generated by the detector 66 from the return light into a digital signal for subsequent decoding by a microprocessor or controller 70 into data indicative of the symbol being read. The aforementioned components, except for the controller 70, is depicted in FIG. 1 as a data capture assembly 48.

FIG. 2 depicts an imaging reader 50 for imaging targets, such as indicia or coded symbols to be electro-optically read, which may also use, and benefit from, the present invention. The imaging reader 50 includes a one- or two-dimensional, solid-state imager 30, preferably a CCD or a CMOS array, mounted in the portable handheld housing 42 having the handle 44 on which the trigger 10 for initiating reading is mounted. The imager 30 has an array of image sensors operative, together with an imaging lens assembly 31, for capturing return light reflected and/or scattered from the symbol through the window 46 during the imaging to produce an electrical signal indicative of a captured image for subsequent decoding by the controller 70 into data indicative of the symbol being read.

The imaging reader 50 includes an illuminator 32 for illuminating the symbol during the imaging with illumination light directed from an illumination light source through the window 46. Thus, the return light may be derived from the illumination light and/or ambient light. The illumination light source comprises one or more light emitting diodes (LEDs) or a laser. An aiming light source 34 may also be provided for emitting an aiming beam and for projecting an aiming light pattern or mark on the symbol prior to imaging. The aforementioned components, except for the controller 70, is depicted in FIG. 2 as a data capture assembly 58.

In operation of the imaging reader 50, the controller 70 sends a command signal to drive the illuminator LEDs/laser 32, typically continuously, or sometimes periodically, during scanning, and energizes the imager 30 during an exposure time period of a frame to collect light from the symbol during a short time period, say 500 microseconds or less. A typical array needs about 33 milliseconds to read the entire target image and operates at a frame rate of about 30 frames per second. The array may have on the order of one million addressable image sensors.

Also shown in FIGS. 1-2 is a printed circuit board (PCB) 60 in the handle 44 on which a rechargeable battery 72 and a radio frequency (RF) transceiver 74 are mounted. The rechargeable battery 72 supplies electrical power to all the electrical components in the readers 40, 50 in the handheld mode. The RF transceiver 74 provides bi-directional communication with other electronic devices, such as a host computer, having a corresponding RF transceiver via an RF wireless link and can be implemented as, for example, a spread spectrum radio transceiver. This transceiver 74 receives decoded data to be transmitted from the controller 70. Bluetooth (trademark) technology can be employed for such wireless RF communications. Bluetooth is an open standard for short-range transmission of digital voice and data between devices and supports point-to-point and multipoint applications. Another standard for providing a wireless local area network, which has achieved widespread use, is international standard IFO/IEC standard 8802-11, which is also ANSI/IEEE Standard 802.11 (herein Standard 802.11). This standard provides a uniform specification for a wireless local area network media access control (MAC) and physical layer (PHY) so that equipment from multiple sources works together. Other communication standards, including proprietary protocols, could also advantageously be used.

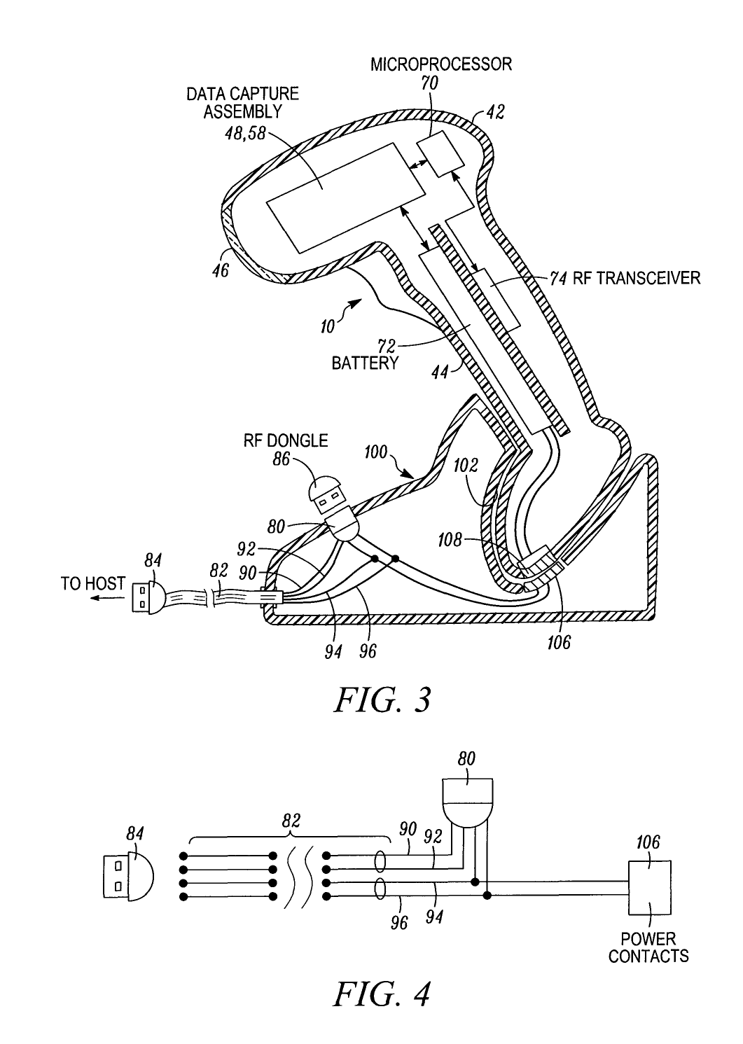

As shown in FIG. 3, reference numeral 100 identifies a docking station for supporting the housing 42 of the reader of FIG. 1 or FIG. 2 in a docked state when the housing 42 is not in the handheld mode, for example, when it is desired to recharge the rechargeable battery 72 on-board the housing 42, or to conveniently park the housing 42 when not in active use. Station 100 includes a support or housing having a compartment 102 for receiving and holding the housing 42. Electrical power contacts 106 are provided on the station 100 for mating with electrical charging contacts 108 on the housing 42 to enable mutual electrical recharging contact in the docked state, as described below.

In accordance with one aspect of this invention, a universal serial bus (USB) socket interface 80 is mounted on the docking station 100, and a USB extension cable 82 has one cable end connected to the USB socket interface 80. The USB cable 82 extends away from the docking station 100 for a selectable distance, which varies depending upon the particular application. The opposite cable end of the cable 82 terminates in a USB plug interface 84. A radio frequency (RF) peripheral 86, also known as an RF dongle, is connected to the USB socket interface 80. The RF dongle has an RF transceiver operative for wireless RF communication with the RF transceiver 74 in the respective reader when the reader is not supported by the docking station 100. The USB plug interface 84 is connected to a host, e.g., a cash register at a retail venue, to enable the wireless RF communication to be performed between the reader and the host.

Preferably, the USB cable 82 is connected to the power contacts 106 on the docking station 100 for mating with the charging contacts 108 connected to the rechargeable battery 72 in the reader to charge the battery 72 when the reader is supported by the docking station 100. As best shown in the wiring diagram of FIG. 4, the USB cable 82 has four wires 90, 92, 94, 96 connected to the USB socket interface 80, and two of the wires 94, 96 are also connected to the power contacts 106. The wires 90, 92 of the USB cable 82 carry data, whereas the wires 94, 96 carry power. For a non-enumerated device, the wires 94, 96 can carry a current up to 100 milliamperes. This current can be used for recharging. If more current is needed for recharging in a particular application, then a power jack can be mounted on the docking station 100, and a larger power supply can be connected to the power jack.

Hence, in accordance with this invention, the docking station 100 is less expensive than heretofore, because RF transceiver circuitry and power recharging circuitry are no longer required to be accommodated therein. Instead, the separate RF dongle provides the RF transceiver circuitry, and power for recharging is supplied directly from the USB wires 94, 96. Also, better access to the USB socket interface is obtained, because the USB socket interface 80 is readily accessible at the docking station, and not the back of the host. An operator need no longer stick his or her head and hand to the back of the host to gain access to the USB socket interface for insertion and pulling out a USB plug interface on a USB peripheral.

It will be understood that each of the elements described above, or two or more together, also may find a useful application in other types of constructions differing from the types described above. For example, different housing configurations and station configurations could be employed. As another example, the USB socket interface need not be provided on the docking station. In some applications, it is sufficient if the docking station serves only as a recharging station, in which case, RF communication could be provided by RF transceivers in the host and the reader.

While the invention has been illustrated and described as embodied in docking stations having extended USB interfaces, especially for supporting wireless electro-optical readers, it is not intended to be limited to the details shown, since various modifications and structural changes may be made without departing in any way from the spirit of the present invention.

Although the preferred embodiments have been described with reference to exemplary handheld symbol readers, it will be appreciated by those skilled in the art that the docking station and method described herein may be used with equal benefit for other types of electrical and electronic devices, e.g., mobile computers, telephones, music players, etc. Accordingly, this invention is not intended to be solely limited to use only with symbol readers.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

I claim:

1. A docking station, comprising:
a support for supporting a portable electro-optical reader;
a universal serial bus (USB) socket interface supported by the support; and
a USB extension cable connected to the USB socket interface, the USB cable extending away from the support and terminating in a USB plug interface.

2. The docking station of claim 1, and a radio frequency (RF) peripheral connected to the USB socket interface, for wireless RF communication with the reader when the reader is not supported by the support.

3. The docking station of claim 2, wherein the USB plug interface is connected to a host to enable the wireless RF communication between the reader and the host.

4. The docking station of claim 1, wherein the USB cable is connected to power contacts on the support for mating with charging contacts connected to a rechargeable battery in the reader to charge the battery when the reader is supported by the support.

5. The docking station of claim 4, wherein the USB cable has four wires connected to the USB socket interface, and wherein two of the wires are also connected to the power contacts.

6. The docking station of claim 1, wherein the reader includes a housing held by an operator away from the docking station in a handheld mode of operation in which the reader sweeps a laser beam across a symbol to be electro-optically read, and wherein the housing is supported by the support in a docked mode.

7. The docking station of claim 1, wherein the reader includes a housing held by an operator away from the docking station in a handheld mode of operation in which the reader detects return light from a symbol to be electro-optically read with a solid-state imager, and wherein the housing is supported by the support in a docked mode.

8. A method of configuring a docking station, comprising the steps of:
supporting a portable electro-optical reader on a support;
supporting a universal serial bus (USB) socket interface on the support;
connecting a USB extension cable to the USB socket interface, and extending the USB cable away from the support; and
terminating the USB cable in a USB plug interface.

9. The method of claim 8, and connecting a radio frequency (RF) peripheral to the USB socket interface, for wireless RF communication with the reader when the reader is not supported on the support.

10. The method of claim 9, and connecting the USB plug interface to a host to enable the wireless RF communication between the reader and the host.

11. The method of claim 8, and connecting the USB cable to power contacts on the support for mating with charging contacts connected to a rechargeable battery in the reader to charge the battery when the reader is supported by the support.

12. The method of claim 11, and configuring the USB cable with four wires all connected to the USB socket interface, and connecting two of the wires also to the power contacts.

13. The method of claim 8, and holding a housing of the reader by an operator away from the docking station in a handheld mode of operation in which the reader sweeps a laser beam across a symbol to be electro-optically read, and supporting the housing by the support in a docked mode.

14. The method of claim 8, and holding a housing of the reader by an operator away from the docking station in a handheld mode of operation in which the reader detects return light from a symbol to be electro-optically read with a solid-state imager, and supporting the housing by the support in a docked mode.

15. A docking station, comprising:
a support for supporting a portable electrical device having charging contacts connected to a rechargeable battery, the support having power contacts for mating with the charging contacts when the electrical device is supported by the support; and
a universal serial bus (USB) extension cable extending away from the support and terminating in a USB plug interface, the USB cable being connected to the power contacts on the support for charging the battery through the charging contacts when the electrical device is supported by the support.

16. The docking station of claim 15, and a USB socket interface supported by the support; and wherein the USB cable is connected to the USB socket interface; and a radio frequency (RF) peripheral connected to the USB socket interface, for wireless RF communication with the electrical device when the electrical device is not supported by the support.

17. The docking station of claim 16, wherein the USB plug interface is connected to a host to enable the wireless RF communication between the electrical device and the host.

18. The docking station of claim 16, wherein the USB cable has four wires connected to the USB socket interface, and wherein two of the wires are also connected to the power contacts.

19. The docking station of claim 15, wherein the USB cable has two wires connected to the power contacts.
